(19) United States
(12) Patent Application Publication
(10) Pub. No.: US 2020/0333166 A1
(43) Pub. Date: Oct. 22, 2020

(54) Object-Operated Machine

(71) Applicant: Tremolant Inc., Gatineau (Quebec) (CA)

(72) Inventor: Luis Pablo Estable, Gatineau (Quebec) (CA)

(21) Appl. No.: 16/847,550

(22) Filed: Apr. 13, 2020

Related U.S. Application Data
(60) Provisional application No. 62/833,596, filed on Apr. 12, 2019.

(51) Int. Cl. G01D 5/04; G01D 5/12; G06N 3/08

(52) U.S. Cl. CPC G01D 5/04; G06N 3/08; G01D 5/12

(57) ABSTRACT

Disclosed herein is a technique to convert a coin-op machine to be operated using an object thereby providing an object-operated machine. An object detector is connected to the coin-op mechanism in lieu of the coin detector typically found in coin-op machines. Examples of objects that are enabled to be used by the present application are business cards, forms, and recyclable objects such as cans, bottles, and the like. Examples of object detectors that are disclosed by the present application are electromechanical lever actuator assemblies, business card scanners, and convolution neural network based object detectors.

### TECHNICAL FIELD

This application relates to machines that can be operated using coins or cards in general, and to an object-operated machine, in particular.

### BACKGROUND OF THE APPLICATION

It is known to operate coin-op machines using coins. Examples of coin-op machines are, without limitation, pinball machines, gumball machines, jukeboxes, arcade game machines, slot machines, vending machines, laundry machines, mechanical rides, and the like. All of these machines operate after an operator inserts one or more coins.

### SUMMARY

According to one aspect of the present application, there is provided a technique to convert coin-op machine to be operated using an object thereby providing an object-operated machine. An object detector is connected to the coin-op mechanism in lieu of the coin detector typically found in coin-op machines. Examples of objects that are enabled to be used by the present application are business cards, forms, and recyclable objects such as cans, bottles, and the like. Examples of object detectors that are disclosed by the present application are electromechanical lever actuator assemblies, business card scanners, and convolution neural network based object detectors.

According to one aspect of the present application, there is provided an apparatus for operating a coin-operated machine using an object other than a traditional coin, the machine normally operable when receiving an operation input signal from a coin actuator, the apparatus comprising: an object signal generator to generate an object signal; a connecting component for connecting the object signal to the operation input signal of the coin-operated machine; and an object detection component for triggering the object signal generator to generate the object signal connected to the operation input signal of the coin-operated machine in response to the object being detected by the apparatus; thereby enabling the coin-operated machine to be operable using the object. In some embodiments, the signal generator and the object detection component are provided by an electromechanical lever actuator assembly. In some embodiments, the electromechanical lever actuator assembly includes a lever actuator including a wire. In some embodiments, electromechanical lever actuator assembly includes a lever actuator including a plate. In some embodiments, the object signal generator includes a relay for driving the operation input signal of the coin-operated machine. In some embodiments, there is included a microcomputer for generating a general purpose input output (GPIO) signal to drive the relay. In some embodiments, the microcomputer includes actuator logic for driving the GPIO signal. In some embodiments, the object detection component includes a neural network inference graph. In some embodiments, there is included a neural network training component for training the neural network inference graph to detect specific classes of objects. In some embodiments, there is included one of a camera or a scanner.

Other aspects and features of the present application will become apparent to those ordinarily skilled in the art upon review of the following description of specific embodiments of a object-operated machine in conjunction with the accompanying drawing figures.

### BRIEF DESCRIPTION OF THE DRAWINGS

Embodiments of the present application will now be described, by way of example only, with reference to the accompanying drawing figures, wherein:

FIG. 1 is a block diagram of an exemplary device including specific components that could be used as a general purpose computer or application specific computer with embodiments of the application;

FIG. 2 is a block diagram of an exemplary collection of data representations for a bit, a nibble, a byte, a 16 bit, a 32 bit and a 64 bit values;

FIG. 3 is a block diagram of an exemplary collection of data types that uses the data representations of FIG. 2;

FIG. 4 is a block diagram of an exemplary instruction set that can be used to encode computer instructions;

FIG. 5 illustrates a coin-op pinball machine;

FIG. 6 illustrates a coin-op gumboil machine;

FIG. 7 illustrates a coin-op labyrinth machine;

FIG. 8 illustrates a ticket collection box that is ideal for collecting business cards, raffle tickets, suggestions, ballots and more;

FIG. 9 illustrates a first embodiment of an object detector that has been integrated into the ticket box of FIG. 8;

FIG. 10 is a front view of the object detector of FIG. 9;

FIG. 11A shows a business card before it drops onto the object detector;

FIG. 11B shows the business card dropping towards the plate that acts as a lever;

FIG. 11C shows the business card striking the lever plate;

FIG. 11D shows the lever plate actuating the actuator;

FIG. 11E shows the business card rotating off of the lever plate;

FIG. 11F shows the lever plate returning to a rest position to it and the business card falling into the ticket box;

FIG. 12A shows the back of the scanner;

FIG. 12B shows the top of the scanner;

FIG. 12C shows the front of the scanner;

FIG. 12D shows a front perspective view of the scanner;

FIG. 12E shows a business card being scanned;

FIG. 12F shows a form being scanned;

FIG. 13 illustrates a preferred embodiment of an object detector;

FIG. 14 is a front view of the object detector of FIG. 13;

FIG. 15A shows a business card before it is driven onto the object detector;

FIG. 15B shows the business card being driven towards the plate that acts as a lever;

FIG. 15C shows the business card striking the lever plate;

FIG. 15D shows the lever plate actuating the actuator;

FIG. 15E shows the business card rotating off of the lever plate;

FIG. 15F shows the lever plate returning to a rest position to it and the business card falling into the ticket box;

FIG. 16 shows the coin-op pinball machine of FIG. 5 that has been enabled to be object-operated using the object-detector of FIGS. 13, 14, and 15-A-15F;

FIG. 17 shows the coin-op gumboil machine of FIG. 6 that has been enabled to be object-operated using the object-detector of FIGS. 13, 14, and 15-A-15F;

FIG. 18 shows the coin-op labyrinth machine of FIG. 7 that has been enabled to be object-operated using the object-detector of FIGS. 13, 14, and 15A-15F;

FIG. 19 shows a coin-op arcade machine that has been enabled to be object-operated using the object-detector of FIGS. 13, 14, and 15A-15F;

FIG. 20 shows a coin-op jukebox machine that has been enabled to be object-operated using the object-detector of FIGS. 13, 14, and 15A-15F;

FIG. 21 shows a coin-op pinball machine that has been enabled to be object-operated using a can object-detector;

FIG. 22 illustrates an embodiment of an object detector that has been integrated into a box with a closed door lock;

FIG. 23 illustrates an embodiment of an object detector that has been integrated into a box with an open door lock;

FIG. 24 is a flowchart illustrating four steps that can be taken in order to convert a coin-operated machine to be object-operated;

FIG. 25 illustrates an embodiment of an object detector having multiple examples of object actuators connected to an object-operated machine according to a preferred embodiment of the application;

FIG. 26 lists python source code to resize images and split them into the training and validation set of FIG. 25;

FIG. 27A lists source code that can be executed in a shell script in order to use the object API, such as bash in Ubuntu of the neural network training machine of FIG. 25;

FIG. 27B lists instructions in python source code so that the labels can be converted;

FIG. 28A lists instructions that can be executed on the neural network training machine of FIG. 25 to retrain the model with data specific to the objects that are desired to be detected FIG. 28B lists instructions that can be executed on the neural network training machine of FIG. 25 to provide the neural network inference graph of FIG. 25;

FIG. 28C lists python code that can be executed on the microcomputer of FIG. 25 to provide the actuator logic block of FIG. 25; and

FIG. 29 illustrates an embodiment of an object detector having multiple examples of object actuators connected to an object-operated machine according to a preferred embodiment of the application.

Like reference numerals are used in different figures to denote similar elements.

### DETAILED DESCRIPTION OF THE DRAWINGS

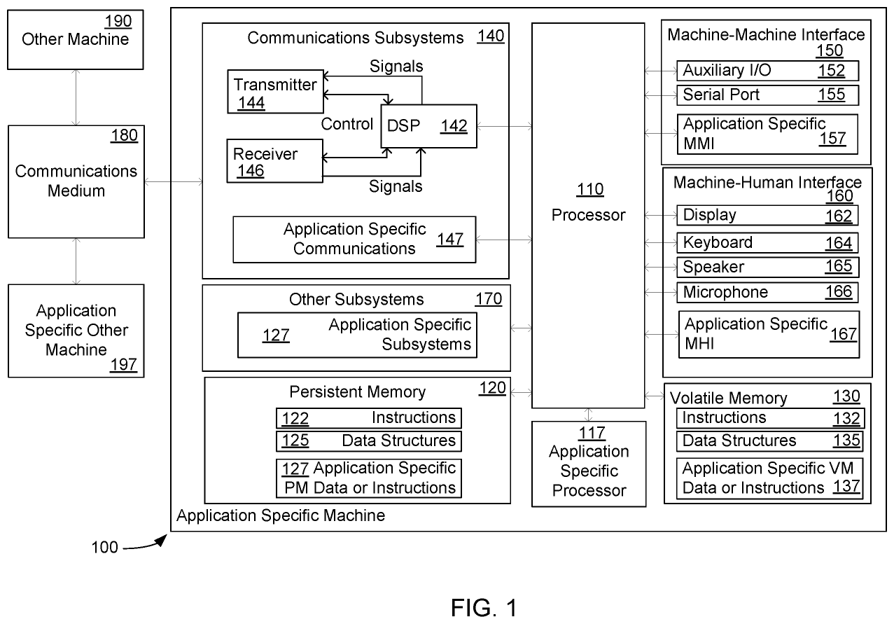

Referring to the drawings, FIG. 1 is a block diagram of an exemplary device including specific components that could be used as a general purpose computer or application specific computer with embodiments of the application. Reference is now made to FIG. 1. FIG. 1 is a block diagram of an exemplary application specific machine environment that can be used with embodiments of the present application. Application Specific Machine 100 is preferably a two-way wireless or wired communication machine having at least data communication capabilities, as well as other capabilities, such as for example audio, and video capabilities. Application Specific Machine 100 preferably has the capability to communicate with other computer systems over a Communications Medium 180. Depending on the exact functionality provided, the machine may be referred to as a smart phone, a data communication machine, client, or server, as examples.

Where Application Specific Machine 100 is enabled for two-way communication, it will incorporate communication subsystem 140, including both a receiver 146 and a transmitter 144, as well as associated components such as one or more, preferably embedded or internal, antenna elements (not shown) if wireless communications are desired, and a processing module such as a digital signal processor (DSP) 142. As will be apparent to those skilled in the field of communications, the particular design of the communication subsystem 140 will be dependent upon the communications medium 180 in which the machine is intended to operate. For example, Application Specific Machine 100 may include communication subsystems 140 designed to operate within the 802.11 network, Bluetooth™ or LTE network, both those networks being examples of communications medium 180 including location services, such as GPS. Communications subsystems 140 not only ensures communications over communications medium 180, but also application specific communications 147. An application specific processor 117 may be provided, for example to process application specific data, instructions, and signals, such as for example for GPS, near field, or other application specific functions. Depending on the application, the application specific processor 117 may be provided by the DSP 142, by the communications subsystems 140, or by the processor 110, instead of by a separate unit.

Network access requirements will also vary depending upon the type of communications medium 180. For example, in some networks, Application Specific Machine 100 is registered on the network using a unique identification number associated with each machine. In other networks, however, network access is associated with a subscriber or user of Application Specific Machine 100. Some specific Application Specific Machine 100 therefore require other subsystems 127 in order to support communications subsystem 140, and some application specific Application Specific Machine 100 further require application specific subsystems 127. Local or non-network communication functions, as well as some functions (if any) such as configuration, may be available, but Application Specific Machine 100 will be unable to carry out any other functions involving communications over the communications medium 1180 unless it is provisioned. In the case of LTE, a SIM interface is normally provided and is similar to a card-slot into which a SIM card can be inserted and ejected like a persistent memory card, like an SD card. More generally, persistent Memory 120 can hold many key application specific persistent memory data or instructions 127, and other instructions 122 and data structures 125 such as identification, and subscriber related information. Although not expressly shown in the drawing, such instructions 122 and data structures 125 may be arranged in a class hierarchy so as to benefit from re-use whereby some instructions and data are at the class level of the hierarchy, and some instructions and data are at an object instance level of the hierarchy, as would be known to a person of ordinary skill in the art of object oriented programming and design.

When required network registration or activation procedures have been completed, Application Specific Machine 100 may send and receive communication signals over the communications medium 180. Signals received by receiver 146 through communications medium 180 may be subject to such common receiver functions as signal amplification, frequency down conversion, filtering, channel selection and the like, analog to digital (A/D) conversion. A/D conversion of a received signal allows more complex communication functions such as demodulation and decoding to be performed in the DSP 142. In a similar manner, signals to be transmitted are processed, including modulation and encoding for example, by DSP 142 and input to transmitter 144 for digital to analog conversion, frequency up conversion, filtering, amplification and transmission over the communication medium 180. DSP 142 not only processes communication signals, but also provides for receiver and transmitter control. For example, the gains applied to communication signals in receiver 146 and transmitter 144 may be adaptively controlled through automatic gain control algorithms implemented in DSP 144. In the example system shown in FIG. 1, application specific communications 147 are also provided. These include communication of information located in either persistent memory 120 or volatile memory 130, and in particular application specific PM Data or instructions 127 and application specific PM Data or instructions 137.

Communications medium 180 may further serve to communicate with multiple systems, including an other machine 190 and an application specific other machine 197, such as a server (not shown), GPS satellite (not shown) and other elements (not shown). For example, communications medium 180 may communicate with both cloud based systems and a web client based systems in order to accommodate various communications with various service levels. Other machine 190 and Application Specific Other machine 197 can be provided by another embodiment of Application Specific Machine 100, wherein the application specific portions are either configured to be specific to the application at the other machine 190 or the application specific other machine 197, as would be apparent by a person having ordinary skill in the art to which the other machine 190 and application specific other machine 197 pertains.

Application Specific Machine 100 preferably includes a processor 110 which controls the overall operation of the machine. Communication functions, including at least data communications, and where present, application specific communications 147, are performed through communication subsystem 140. Processor 110 also interacts with further machine subsystems such as the machine-human interface 160 including for example display 162, digitizer/buttons 164 (e.g. keyboard that can be provided with display 162 as a touch screen), speaker 165, microphone 166 and Application specific HMI 167. Processor 110 also interacts with the machine-machine interface 1150 including for example auxiliary I/O 152, serial port 155 (such as a USB port, not shown), and application specific MHI 157. Processor 110 also interacts with persistent memory 120 (such as flash memory), volatile memory (such as random access memory (RAM)) 130. A short-range communications subsystem (not shown), and any other machine subsystems generally designated as Other subsystems 170, may be provided, including an application specific subsystem 127. In some embodiments, an application specific processor 117 is provided in order to process application specific data or instructions 127, 137, to communicate application specific communications 147, or to make use of application specific subsystems 127.

Some of the subsystems shown in FIG. 1 perform communication-related functions, whereas other subsystems may provide application specific or on-machine functions. Notably, some subsystems, such as digitizer/buttons 164 and display 162, for example, may be used for both communication-related functions, such as entering a text message for transmission over a communication network, and machine-resident functions such as application specific functions.

Operating system software used by the processor 110 is preferably stored in a persistent store such as persistent memory 120 (for example flash memory), which may instead be a read-only memory (ROM) or similar storage element (not shown). Those skilled in the art will appreciate that the operating system instructions 132 and data 135, application specific data or instructions 137, or parts thereof, may be temporarily loaded into a volatile 130 memory (such as RAM). Received or transmitted communication signals may also be stored in volatile memory 130 or persistent memory 120. Further, one or more unique identifiers (not shown) are also preferably stored in read-only memory, such as persistent memory 120.

As shown, persistent memory 120 can be segregated into different areas for both computer instructions 122 and application specific PM instructions 127 as well as program data storage 125 and application specific PM data 127. These different storage types indicate that each program can allocate a portion of persistent memory 120 for their own data storage requirements. Processor 110 and when present application specific processor 117, in addition to its operating system functions, preferably enables execution of software applications on the Application Specific Machine 100. A predetermined set of applications that control basic operations, including at least data communication applications for example, will normally be installed on Application Specific Machine 100 during manufacturing. A preferred software application may be a specific application embodying aspects of the present application. Naturally, one or more memory stores would be available on the Application Specific Machine 100 to facilitate storage of application specific data items. Such specific application would preferably have the ability to send and receive data items, via the communications medium 180. In a preferred embodiment, the application specific data items are seamlessly integrated, synchronized and updated, via the communications medium 180, with the machine 110 user's corresponding data items stored or associated with an other machine 190 or an application specific other machine 197. Further applications may also be loaded onto the Application Specific Machine 100 through the communications subsystems 140, the machine-machine interface 150, or any other suitable subsystem 170, and installed by a user in the volatile memory 130 or preferably in the persistent memory 120 for execution by the processor 110. Such flexibility in application installation increases the functionality of the machine and may provide enhanced on-machine functions, communication-related functions, or both. For example, secure communication applications may enable electronic commerce functions and other such financial transactions to be performed using the Application Specific Machine 100.

In a data communication mode, a received signal such as a text message or web page download will be processed by the communication subsystem 140 and input to the processor 110, which preferably further processes the received signal for output to the machine-human interface 160, or alternatively to a machine-machine interface 150. A user of Application Specific Machine 100 may also compose data items such as messages for example, using the machine-human interface 1160, which preferably includes a digitizer/buttons 164 that may be provided as on a touch screen, in conjunction with the display 162 and possibly a machine-machine interface 150. Such composed data items may then be transmitted over a communication network through the communication subsystem 110. Although not expressly show, a camera can be used as both a machine-machine interface 150 by capturing coded images such as QR codes and barcodes, or reading and recognizing images by machine vision, as well as a human-machine interface 160 for capturing a picture of a scene or a user.

For audio/video communications, overall operation of Application Specific Machine 100 is similar, except that received signals would preferably be output to a speaker 134 and display 162, and signals for transmission would be generated by a microphone 136 and camera (not shown). Alternative voice or audio I/O subsystems, such as a voice message recording subsystem, may also be implemented on Application Specific Machine 100. Although voice or audio signal output is preferably accomplished primarily through the speaker 165, display 162 and applications specific MHI 167 may also be used to provide other related information.

Serial port 155 in FIG. 1 would normally be implemented in a smart phone-type machine as a USB port for which communication or charging functionality with a user's desktop computer, car, or charger (not shown), may be desirable. Such a port 155 would enable a user to set preferences through an external machine or software application and would extend the capabilities of Application Specific Machine 100 by providing for information or software downloads to Application Specific Machine 100 other than through a communications medium 180. The alternate path may for example be used to load an encryption key onto the machine through a direct and thus reliable and trusted connection to thereby enable secure machine communication.

Communications subsystems 140, may include a short-range communications subsystem (not shown), as a further optional component which may provide for communication between Application Specific Machine 100 and different systems or machines, which need not necessarily be similar machines. For example, the other subsystems 170 may include a low energy, near field, or other short-range associated circuits and components or a Bluetooth™ communication module to provide for communication with similarly enabled systems and machines.

The exemplary machine of FIG. 1 is meant to be illustrative and other machines with more or fewer features than the above could equally be used for the present application. For example, one or all of the components of FIG. 1 can be implemented using virtualization whereby a virtual Application Specific Machine 100, Communications medium 180, Other Machine 190 or Application Specific Other Machine 197 is provided by a virtual machine. Software executed on these virtual machines is separated from the underlying hardware resources. The host machine is the actual machine on which the virtualization takes place, and the guest machine is the virtual machine. The terms host and guest differentiate between software that runs on the physical machine versus the virtual machine, respectively. The virtualization can be full virtualization wherein the instructions of the guest or virtual machine execute unmodified on the host or physical machine, partial virtualization wherein the virtual machine operates on shared hardware resources in an isolated manner, to hardware-assisted virtualization whereby hardware resources on the host machine are provided to optimize the performance of the virtual machine. Although not expressly shown in the drawing, a hypervisor program can be used to provide firmware for the guest or virtual machine on the host or physical machine. It will be thus apparent to a person having ordinary skill in the art that components of FIG. 1 can be implemented in either hardware or software, depending on the specific application. For example, while testing and developing the Application Specific Machine 100 may be provided entirely using an emulator for the machine, for example a smartphone emulator running Android™ or iOS™. When deployed, real smartphones would be used.

Each component in FIG. 1 can be implemented using any one of a number of cloud computing providers such as Microsoft's Azure™, Amazon's Web Service™, Google's Cloud Computing, or an OpenStack based provider, by way of example only. Thus, as will be apparent to a person having ordinary skill in the relevant field of art, depending on whether the environment in which operate the components of FIG. 1, the Communications medium 180 can be the Internet, an IP based medium such as a virtual, wired, or wireless network, an interconnect back plane on a host machine serving as a back bone between virtual machines and/or other real machines, or a combination thereof. For example, in the case of the communications subsystems 140, the Transmitter 144, Receiver 146 and DSP 142 may be unnecessary if the application specific machine is provided as a virtual machine. Likewise, when the application is a server provided as a virtual machine, the machine-human interface 160 and machine-machine interface 150 may be provided by re-use of the resources of the corresponding host machine, if needed at all.

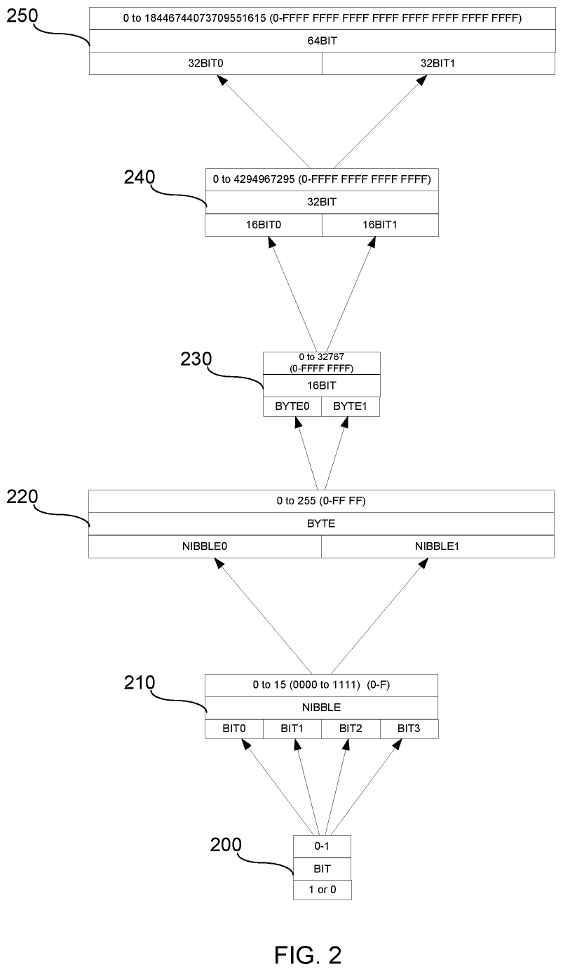

FIG. 2 is a block diagram of an exemplary collection of data representations for a bit, a nibble, a byte, a 16 bit, a 32 bit and a 64 bit values. A bit 200 is a binary data structure that can take on one of two values, typically represented by a 1 or a 0. In alternative physical realizations of a bit, the bit can be stored in read only memory, random access memory, storage medium, electromagnetic signals. Bits are typically realized in large multiples to represent vast amounts of data. A grouping four bits is called a nibble 210. Two nibbles form a bye 220. The byte 220 is of particular importance as most data structures that are larger groupings of bits than one byte are typically made up of multiples of bytes. Two bytes form 1 16 BIT 230 structure. Two 16 BIT structures form a 32 BIT 240 structure. Two 32 BIT structures form a 64 BIT 750 structure.

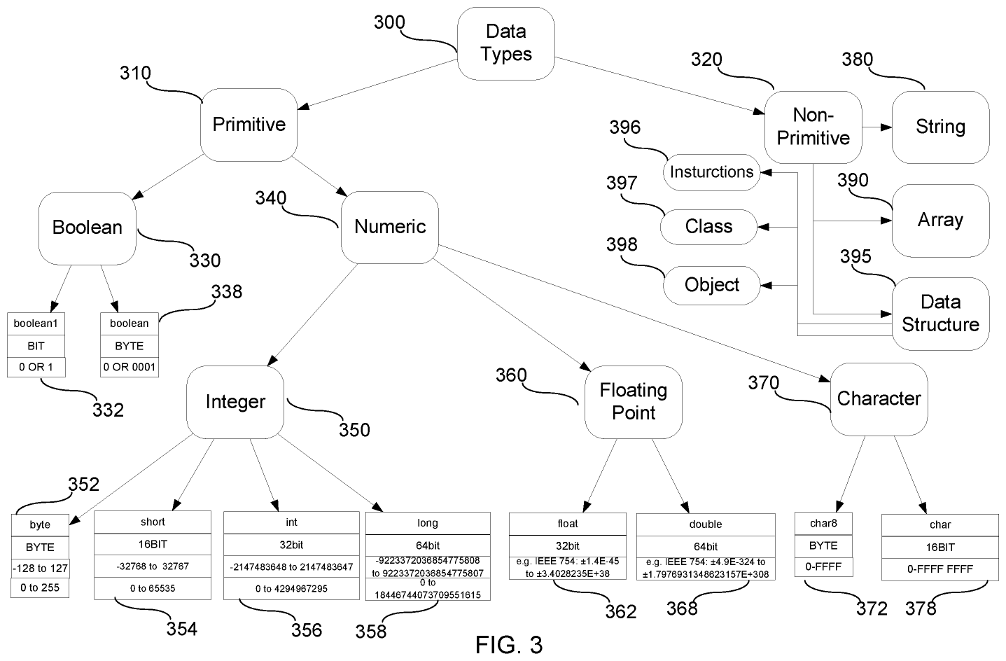

FIG. 3 is a block diagram of an exemplary collection of data types that uses the data representations of FIG. 2. Data types 300 are abstractions that represent application specific data using either primitive 310 or non-primitive constructs 320 The most fundamental primitive data type is a Boolean 330 data type, which can be represented using a single bit with the boolean1 332 data structure, or more frequently using a Boolean 338 data structure that uses a single byte. More complex data types of the primitive data type is a Numeric 340 data type. Three broad examples of the Numeric 340 data type are the Integer 350 data type, the Floating Point 360 data type, and the Character 370 data types. A byte 352, a short 364, an int 366, and a long 368 are examples of Integer 350 Numeric 340 Primitive 310 Data Types 300 using a BYTE, 16 BIT, 16 BIT, 32 BIT and 64 BIT representation respectively. A float 362 and a double 368 are examples of Floating Point 360 Numeric 340 Primitive 310 Data Types and are represented using 32 BIT and 64 BIT representations respectively. Depending on the application, Integer 350 and Floating Point 360 Data Types 300 can be interpreted as signed or unsigned values. In contrast, Character 380 data types represent alphanumeric information. A char8 372 is represented using a single byte, while a char 378 is represented using a 16 BIT value, such as for example in ASCII or Unicode respectively. Having defined some example Primitive 310 Data Types 300, it is possible to build up Non-Primitive 320 Data Types 300 by combining Primitive 310 ones, such as for example a String 380 which is a collection of consecutive Character 370, an Array which is a collection of Primitive 310, and more generally, a Data Structure 395 which can be a collection of one or more Data Types 300. Of particular interest are instances of Data Structure 395 that can represent Instructions 396, Class 397, and Object 398. Instructions 396 are data structures that are processed by a given processor to implement a specific method or process. Some Instructions 396 work effectively with corresponding data and are packaged into templates that can be reused, such as code libraries, or as is shown in the drawing in a Class 397 which is a collection of attributes including Data Types 300 and methods including Instructions 396. A Class 397 can be arranged relative to other Classes in order to provide a Class hierarchy, a linked Data Structure 395 whereby one specific Class 397 is related to one or more other Classes by either “is a” or “has a” relationships. Furthermore, instances of a Class 397 can be instantiated into instances of an Object 398 of that given Class 397 at run time to provide a runtime context for attributes. Thus, it is possible to show the relationship between various Object 398 of specific Class 397 using entity relationship diagrams where each Object 398 or Class 397 is related to others using “is a” and “has a” relationships, and where attributes represent Data Types, and methods represent Instructions 396. Typically, attributes are shown using a variable name and methods are shown using a function name preceded by a set of parentheses “( )”. Thus, when illustrated in the present drawings, it will be understood that a person of ordinary skill in the art will know how to convert from these conventions into the Data Types 300 and Instructions 396 with are ultimately processed by computing systems.

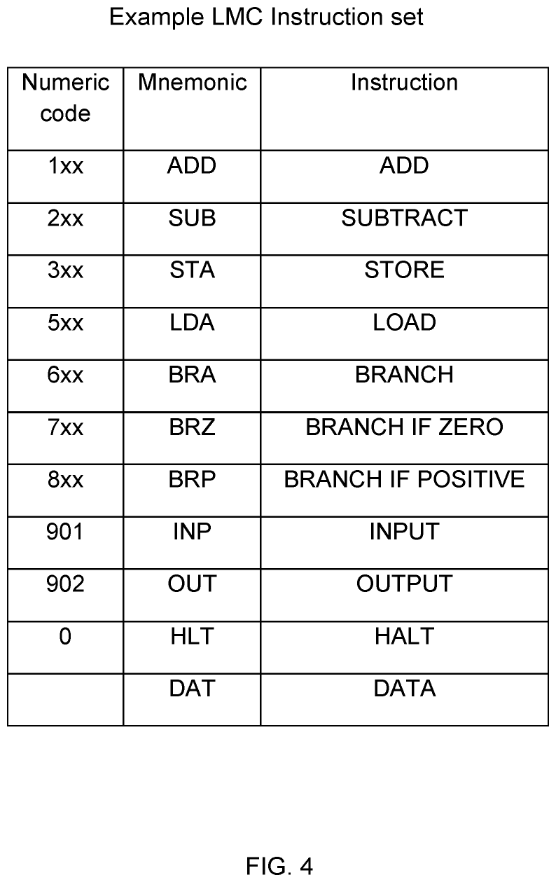

FIG. 4 is a block diagram of an exemplary instruction set that can be used to encode computer instructions. Just like data can be represented in binary form, so can instructions for any one of the example processing units. Data representations and instruction sets are typically dependent on the processing units used, as is known in the art. Nonetheless, for completeness, an exemplary instruction set is shown in FIG. 4, known as the Little Man Computer (LMC) instruction set for a corresponding processing unit, the LMC computer. The first seven instructions in the LMC instruction set include an xx address of a “mailbox”, an analogy for memory, for operations with an accumulator: ADD, SUBTRACT, STORE, LOAD, BRANCH, BRANCH IF 3ERO, BRANCH IF POSITIVE. The next two instructions, INPUT and OUTPUT, are for input and output to the accumulator. The final instruction, HALT is an instruction to signify the end of a series of instructions or a program. The DAT mnemonic is a notational convenience and allows for the inclusion of in-line data in a mnemonic representation of a program. In practice, any one of a number of instruction sets for respective processing units or family of processing units are used, and together referred to as an architecture, such as for example, without limitation the ARM architecture, previously Advanced RISC Machine, originally Acorn RISC Machine, which is a family of reduced instruction set computing (RISC) architectures for computer processors, configured for various environments. It is generally known to be able to translate flowcharts into mnemonics for computer instructions, and then encode those instructions as binary data to be processed by a given processor such that any flowchart shown in this application can be implemented using specific mnemonic or binary computer instructions given a specific architecture. The mnemonic representations are typically known as source code, and when in a form of a series of instructions known as binary code. There are several programming languages, interpreters, compilers and development environments whose purpose is to ultimately convert source code into binary representations of instructions targeting specific computing architectures.

Having described the environment in which the specific techniques of the present application can operate, application specific aspects will be further described by way of example only.

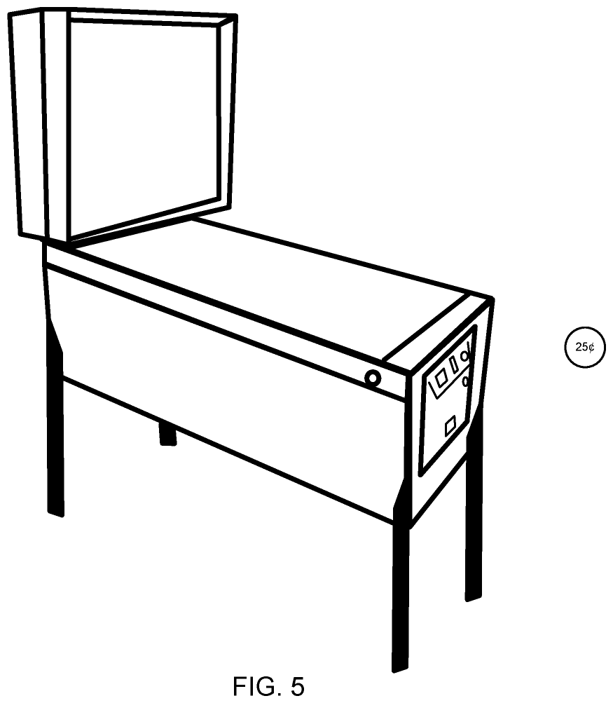

FIG. 5 illustrates a coin-op pinball machine. The pinball machine receives coins, such as a quarter, in order to enable a user to operate the machine. Coins are fed into the machine via a coin slot, after which the user can press the start button in order to operate the machine. In some embodiments, the pinball machine is typically an electromechanical, solid state, or virtual pinball machine. An electromechanical pinball machine is one in which all of the parts of the playfield are electrical or mechanical parts. A solid state pinball machine uses solid state electronics. A virtual pinball machine replaces the playfield and backglass with electronic displays such as high definition plasma, LCD, or OLED displays. It is essentially a videogame version of a pinball machine that is embodied in a cabinet, either purpose built, or up-cycled from an old electromechanical or solid state pinball machine that has all of its guts replaced with an application specific computer of the like illustrated in FIG. 1. The coin detector is usually an electromechanical actuator that only gets triggered if a coin is not rejected when it is inserted into the slot. The actuator is typically of the kind that has two leads, which are short circuited, whenever the lever from the coin detector pushes onto the actuator.

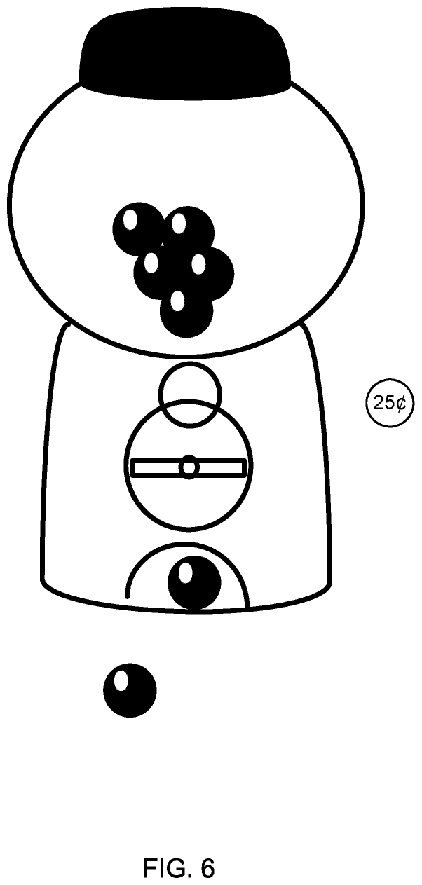

FIG. 6 illustrates a coin-op gumball machine. As with the pinball machine, a gumball machine accepts a coin in a slot. However in order to get at the gumball, the operator twists a mechanism that causes a gumball to drop into the chute. Although gumballs are illustrated, other items, such as toys or the like, can be vended so long as they are of a diameter similar to that of the gumball for which the gumball machine was designed.

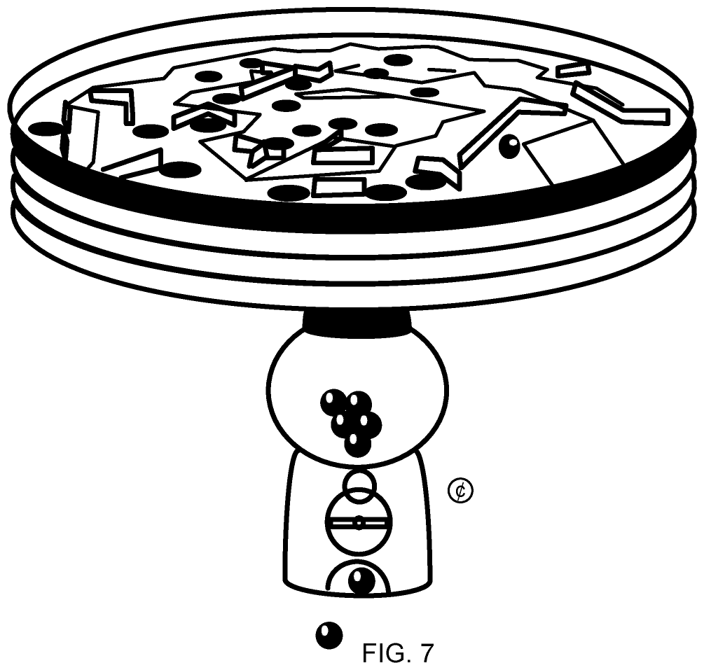

FIG. 7 illustrates a coin-op labyrinth machine. The labyrinth machine is mounted onto a base, in this case a gumball machine, using springs and dampers, such that a group of people can operate the labyrinth by moving it up and down on its edges to cause a ball to move through the labyrinth while trying to avoid traps, such as dead-ends, and holes. When the ball goes into the hole, it winds up in the gumball machine. To play, a user inserts a coin in the gumball machine, and rotates the lever to retrieve a ball. This is only an example coin-op mechanism, and a person of ordinary skill in the art will consider others in view of this disclosure, that are within the contemplated scope of this application. For example, the labyrinth machine need not be supported by the gumball machine and the two may be physically separated. Alternatively, a ball return mechanism can be employed to seal the labyrinth game area away from the players using a glass.

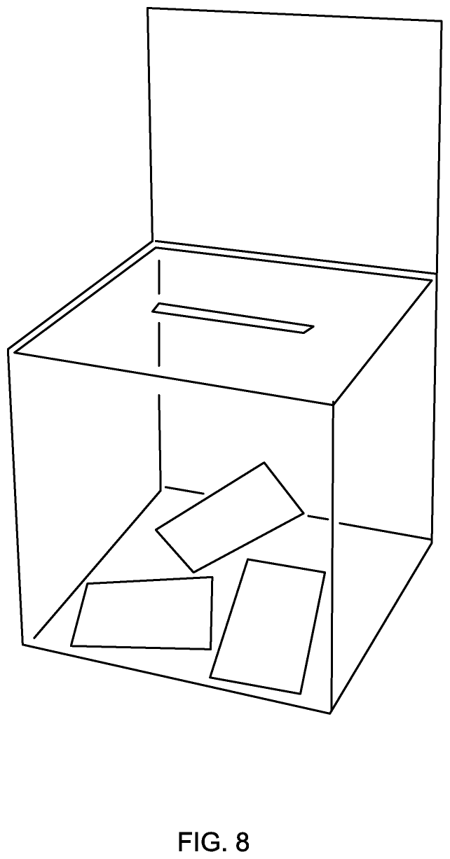

FIG. 8 illustrates a ticket collection box that is ideal for collecting business cards, raffle tickets, suggestions, ballots and more. It is made of durable, clear plastic. The back is a sign holder that accommodates inserts up to 14¾ inches in height by 8 inches in width. The ticket slot is at the top of the box, and enables users to insert the aforementioned items, and many other objects, into the ticket box.

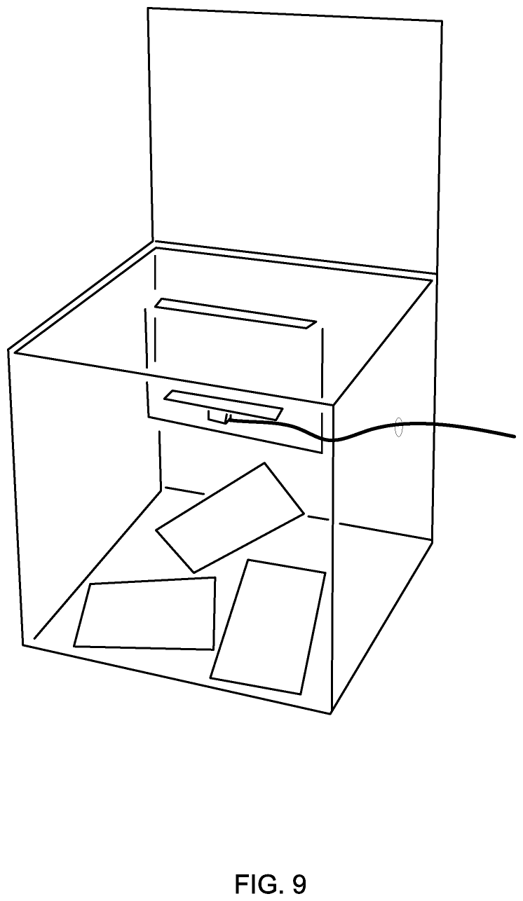

FIG. 9 illustrates a first embodiment of an object detector that has been integrated into the ticket box of FIG. 8. The object detector has a support plate that hangs below the ticket box slot, a lever plate substantially perpendicular to it, and an actuator that is actuated if something strikes the lever plate. Advantageously, a pair of wires exits the ticket box to provide an object detector signal that can be used to operate a typical coin-operated machine thereby turning it into an object-operated machine.

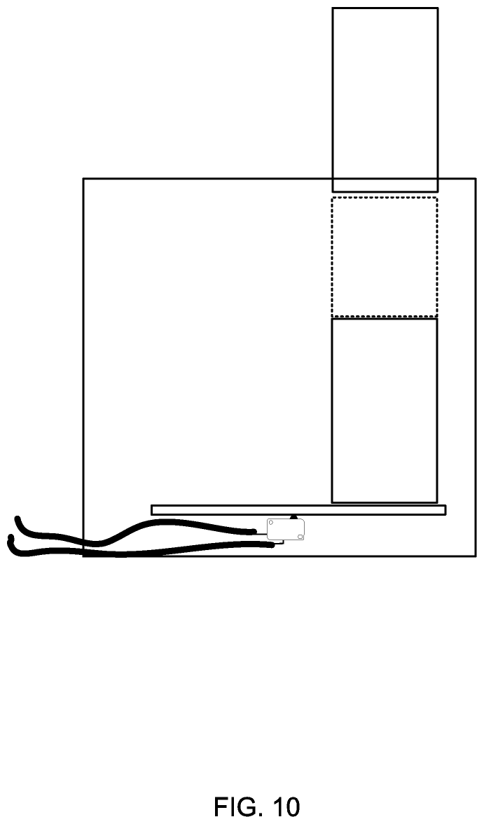

FIG. 10 is a front view of the object detector of FIG. 9. As a business card is dropped, it strikes a lever plate which in turn acts as a lever for an actuator of the kind typically found in coin-op machines such as pinball machines and arcade machines.

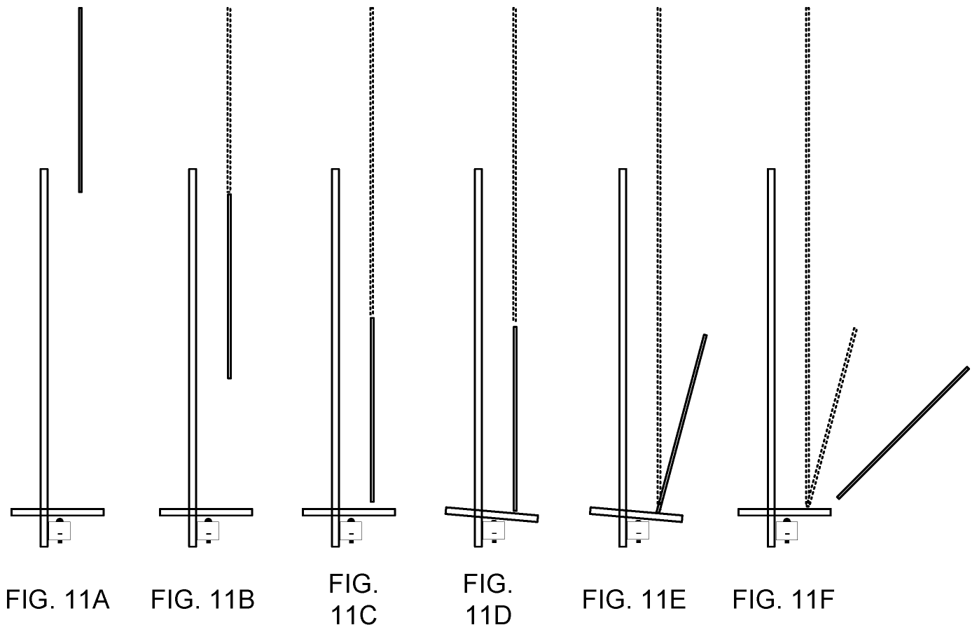

FIGS. 11A-11F are side views of the object detector of FIG. 10. FIG. 11A shows a business card before it drops onto the object detector. FIG. 11B shows the business card dropping towards the plate that acts as a lever. FIG. 11C shows the business card striking the lever plate. FIG. 11D shows the lever plate actuating the actuator. FIG. 11E shows the business card rotating off of the lever plate. FIG. 11F shows the lever plate returning to a rest position to it and the business card falling into the ticket box.

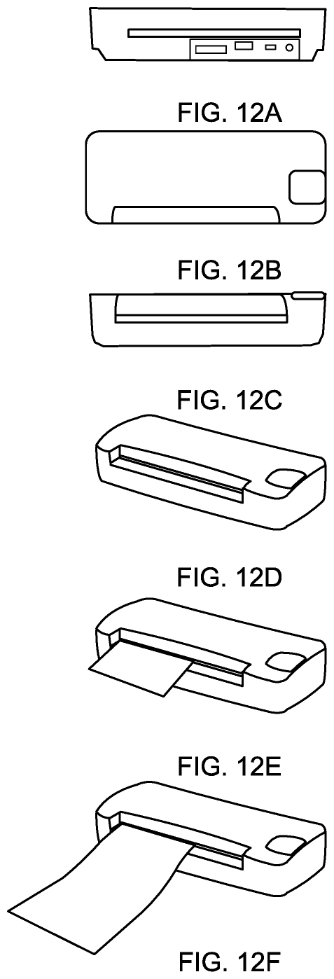

FIGS. 12A-12F illustrate a business card scanner that can also be used to scan forms that are larger than business cards. FIG. 12A shows the back of the scanner. FIG. 12B shows the top of the scanner. FIG. 12C shows the front of the scanner. FIG. 12D shows a front perspective view of the scanner. FIG. 12E shows a business card being scanned. FIG. 12F shows a form being scanned. As shown the scanner includes a scan entry slot, a scan exit slot, an SD/MMC card slot, a USB-A slot, a USB-B slot, and a DC power slot, and a power button. An example scanner is the IS 15 Plus from Avision™, found on Amazon™. Operationally one inserts either or an SD/MMC card, a USB drive, or a connection to a PC so as to receive the scans from the scanner, powers on the scanner, and the scanner will automatically feed a business card or form presented at the scan entry slot, through the scanner, to the scan exit slot while scanning the item. The scanning process is motorized such that when the business card or form leave the exit slot, there is sufficient force to, for example, push a lever.

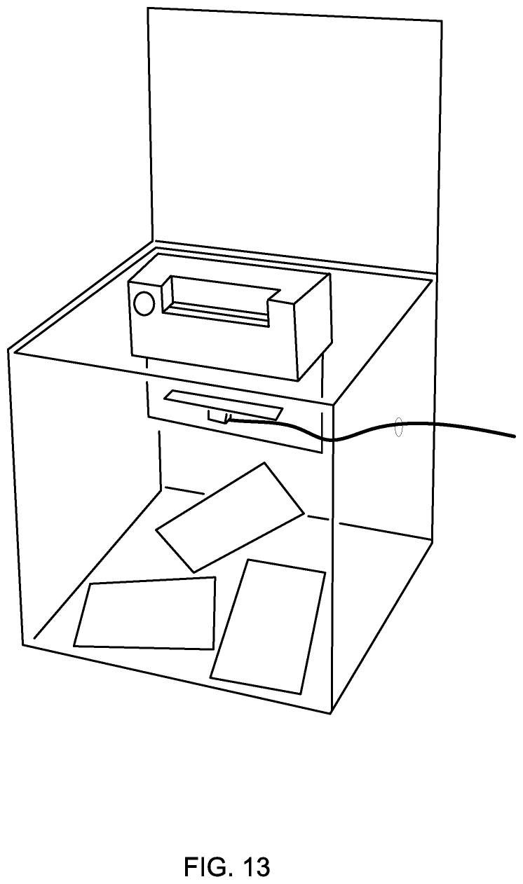

FIG. 13 illustrates a preferred embodiment of an object detector. The object detector incorporates the business card scanner of FIGS. 12A-12F into the object detector of FIGS. 9, 10, 11A-11F. The object detector has a support plate that hangs below the ticket box slot, a lever plate substantially perpendicular to it, and an actuator that is actuated if something strikes the lever plate. Advantageously, a pair of wires exits the ticket box to provide an object detector signal that can be used to operate a typical coin-operated machine thereby turning it into an object-operated machine. Furthermore, the business card scanner is fixed to the support plate such that, as an object is inserted into the scanner, the motor of the scanner drives the object to strike the lever plate while it scans an image of the object. Of particular interest is the case where instead of a form or a business card, a picture is inserted. The resulting image scanned can be validated using a convolutional neural network, such as one based on tensorflow, to determine if it is of a predetermined object type before enabling the object-operated machine. For example, for a specific given application, one may configure the system so as to only accept objects corresponding to pictures of a person practicing a specific activity, such as for example, playing golf. In another application, one may configure the system so as to only detect pictures of dogs. Advantageously, a pair of wires that is short circuited is the signal that is used to indicate that an object has been detected.

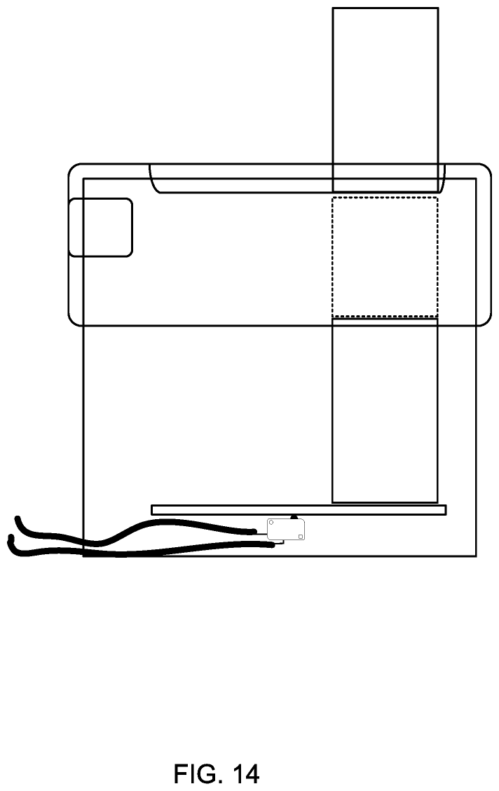

FIG. 14 is a front view of the object detector of FIG. 13. As a business card is driven by the scanner, it strikes a lever plate which in turn acts as a lever for an actuator of the kind typically found in coin-op machines such as pinball machines and arcade machines. Although not shown, this signal can be instead generated by the application specific machine of FIG. 1 using a convolutional neural network to detect an object depicted in an image scanned by the scanner.

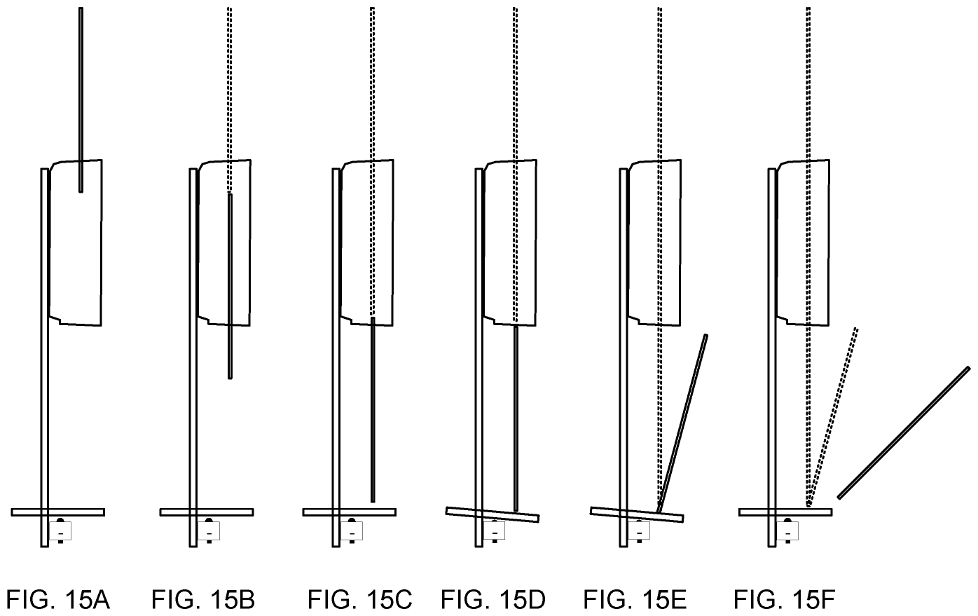

FIGS. 15A-15F are side views of the object detector of FIG. 14. FIG. 15A shows a business card before it is driven onto the object detector. FIG. 15B shows the business card being driven towards the plate that acts as a lever. FIG. 15C shows the business card striking the lever plate. FIG. 15D shows the lever plate actuating the actuator. FIG. 15E shows the business card rotating off of the lever plate. FIG. 15F shows the lever plate returning to a rest position to it and the business card falling into the ticket box.

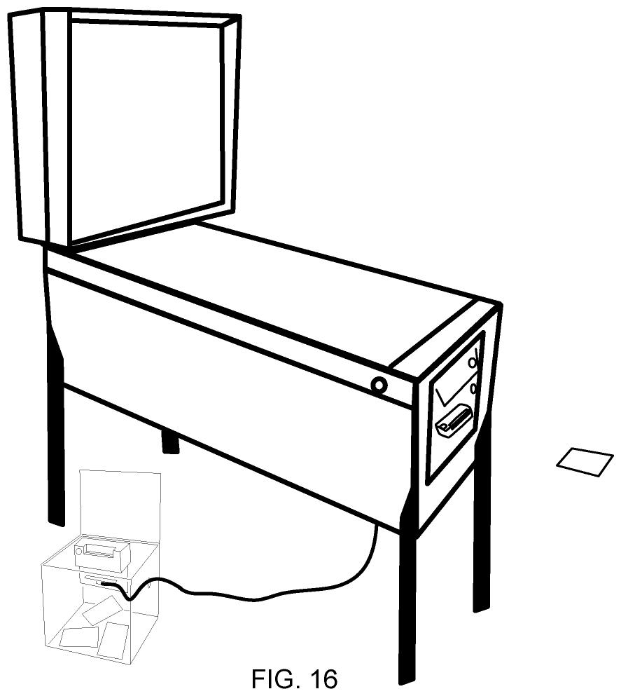

FIG. 16 shows the coin-op pinball machine of FIG. 5 that has been enabled to be object-operated using the object-detector of FIGS. 13, 14, and 15-A-15F. Advantageously, the door no longer has a coin slot and instead has integrated in it the mechanism of FIG. 14. Alternatively, the object detector of FIG. 13 is shown as an external ticket box whereby a promotional message can be displayed to prompt people to insert specific objects into the object detector. A pair of wires connects the object detector to the pinball machine such that when an object is detected the pinball machine is enabled to operate. In alternative embodiments, the application specific machine of FIG. 1 is provided in a virtual pinball machine such that all components, including the convolutional neural network, are integrated into the object-operated pinball machine.

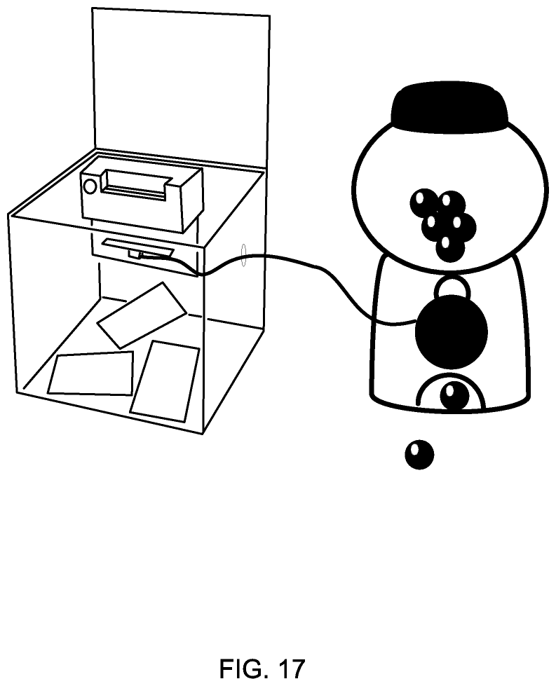

FIG. 17 shows the coin-op gumball machine of FIG. 6 that has been enabled to be object-operated using the object-detector of FIGS. 13, 14, and 15-A-15F. A motor drive has been used to drive the rotation of the lever, which has been modified so as to always rotate freely regardless of the presence of a coin in the mechanism. The motor drive rotates the required amount whenever a signal detecting the object is received via the pair of wires connecting the object detector and the gumball machine.

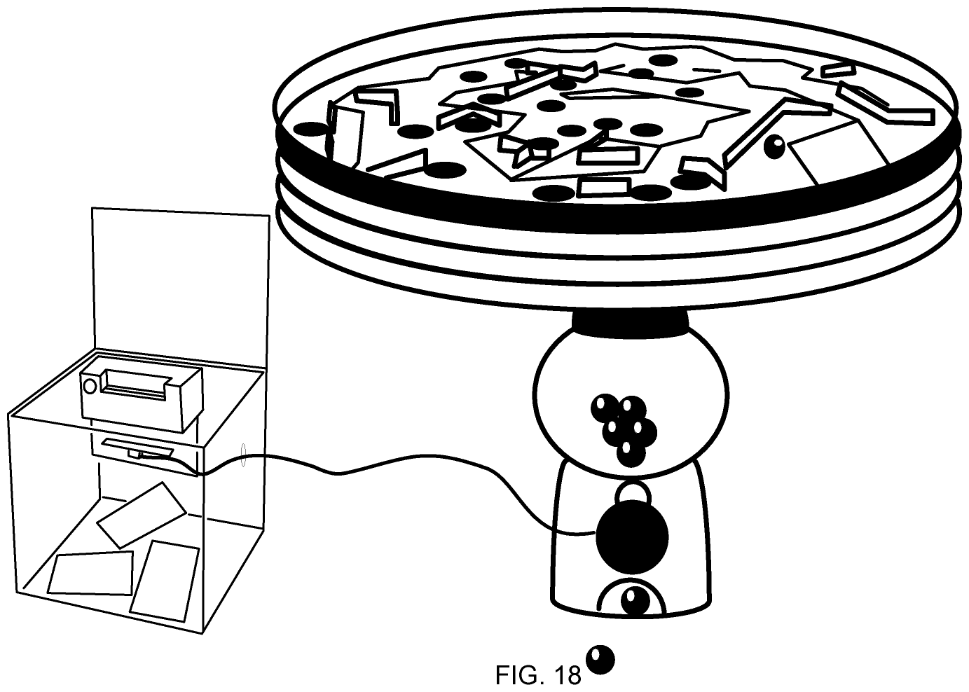

FIG. 18 shows the coin-op labyrinth machine of FIG. 7 that has been enabled to be object-operated using the object-detector of FIGS. 13, 14, and 15A-15F. A motor drive has been used to drive the rotation of the lever, which has been modified so as to always rotate freely regardless of the presence of a coin in the mechanism. The motor drive rotates the required amount whenever a signal detecting the object is received via the pair of wires connecting the object detector and the gumball machine.

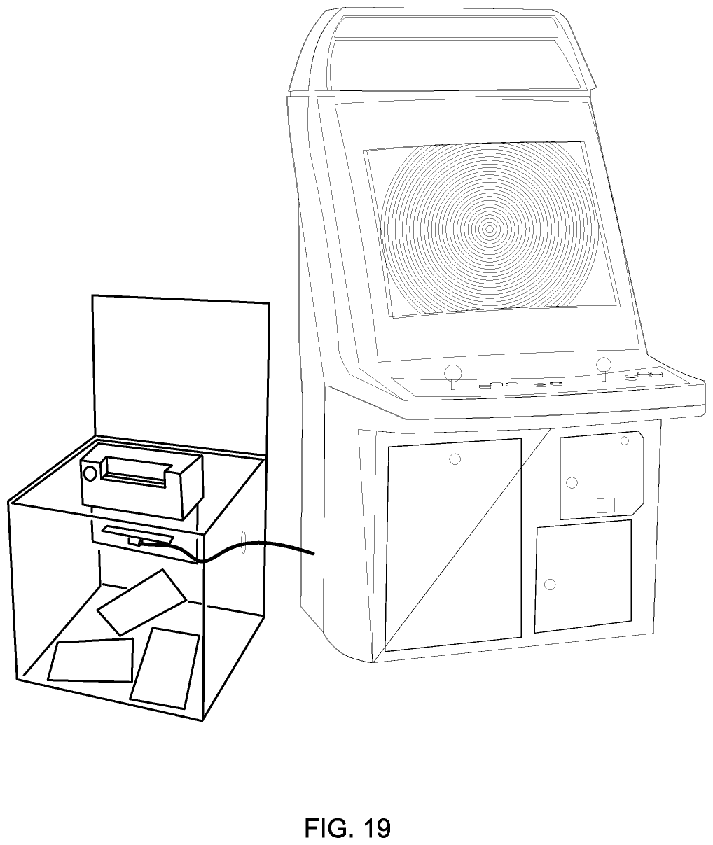

FIG. 19 shows a coin-op arcade machine that has been enabled to be object-operated using the object-detector of FIGS. 13, 14, and 15A-15F.

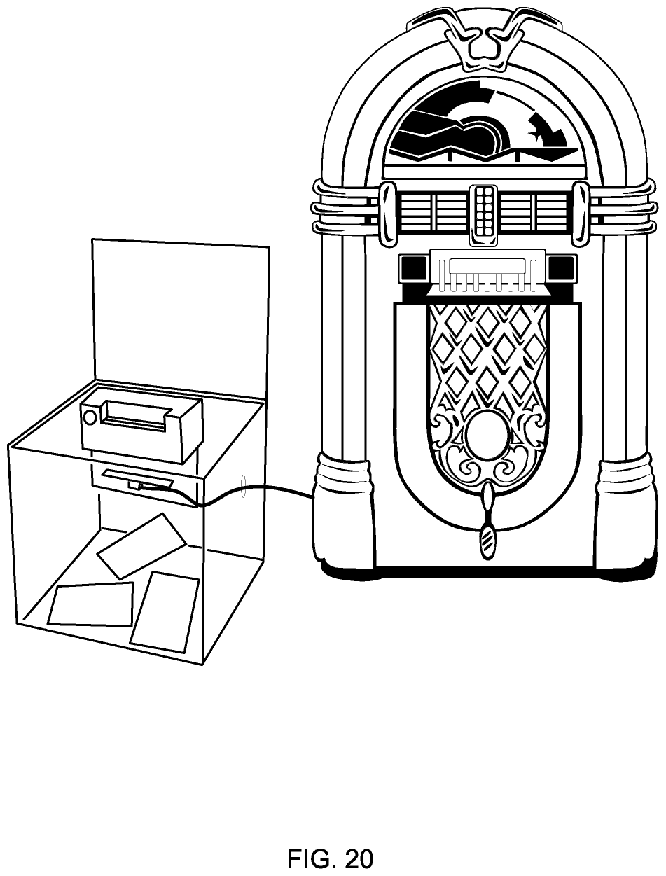

FIG. 20 shows a coin-op jukebox machine that has been enabled to be object-operated using the object-detector of FIGS. 13, 14, and 15A-15F.

Although not expressly shown, it is clear to anyone of ordinary skill in the art in view of the present disclosure, that all manner of coin-op machines, including laundry machines, slot machines, vending machines, and the like, can be enabled to be object-operated using the object-detector of FIGS. 13, 14, and 15A-15F.

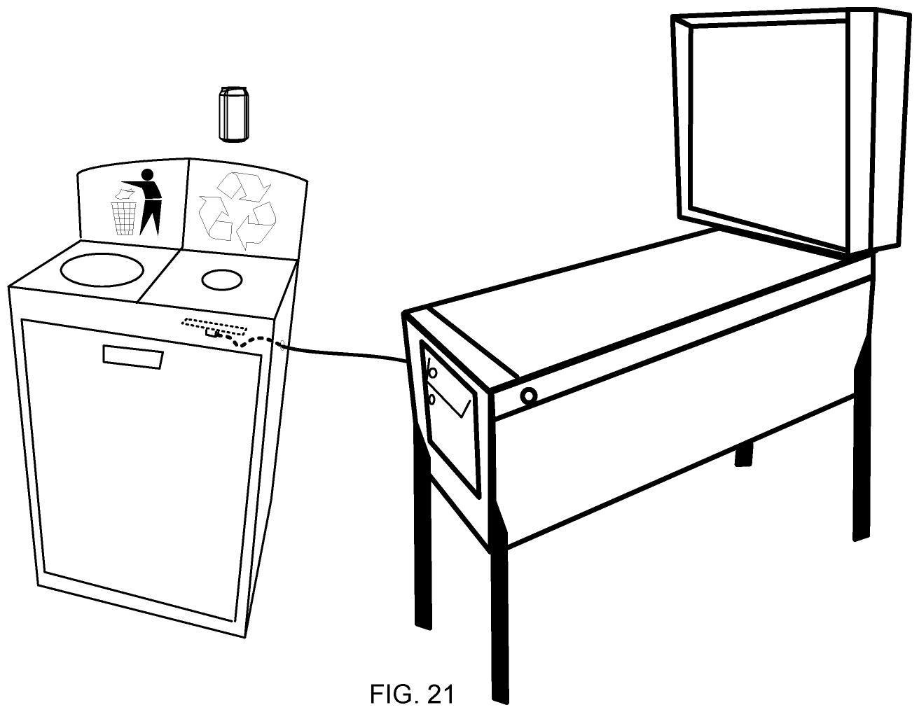

FIG. 21 shows a coin-op pinball machine that has been enabled to be object-operated using a can object-detector. The can object-detector reuses the mechanism of FIG. 10 inside a can recycling bin. When a can is inserted into the recycling bin, it strikes the lever plate, which triggers the actuator to short circuit the pair of wires that are connected to the pinball machine.

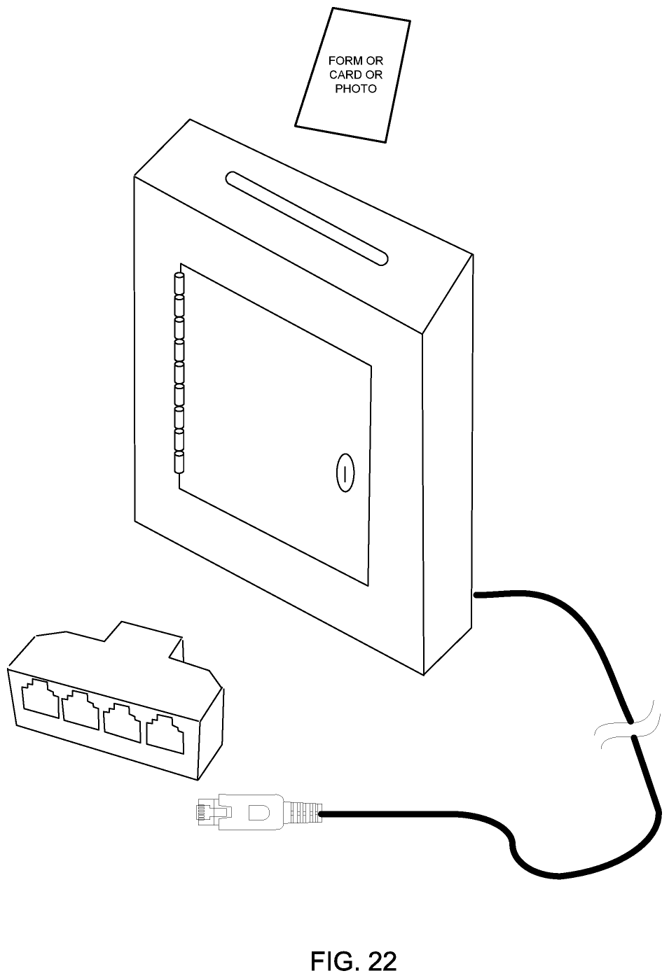

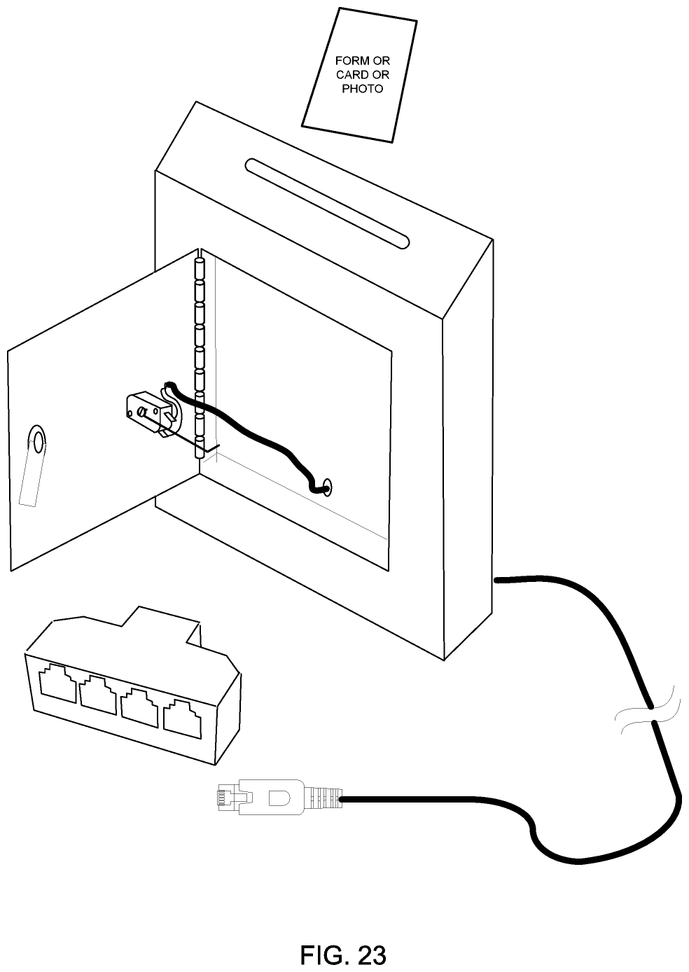

FIG. 22 illustrates an embodiment of an object detector that has been integrated into a box with a closed door lock. FIG. 23 illustrates an embodiment of an object detector that has been integrated into a box with an open door lock. As shown, instead of using a support plate, the box door is used to position an actuator below a slot in the box, and a wire is used instead of a lever plate, substantially perpendicular to the box door, such that the actuator (a coin-op switch) is actuated if something strikes the wire, such as a business card or a form. Although not expressly shown in FIGS. 22 and 23, a motor drive or a scanner can be integrated in the box as well, between the box slot and the actuator's wire. Also shown is the use of an RJ type connector and an RJ type splitter that can facilitate the connecting of the object detector into an existing coin-operated machine.

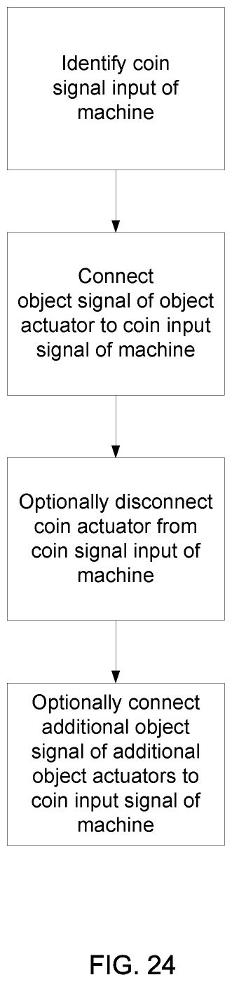

FIG. 24 is a flowchart illustrating four steps that can be taken in order to convert a coin-operated machine to be object-operated. The first step is to identify the coin signal input of the machine. This can usually be done by visual inspection: it is the pairs of wires that connect the control board to the coin actuators on the coin door. The second step is to connect the object signal of the object actuator to the coin input signal of the machine. This can usually be done by cutting or stripping at least one pair of wires that connect the control board to the coin actuators, and connecting a corresponding pair of wires of the object operator to the cut or stripped wires. In a preferred embodiment, an RJ connector is used, substantially as shown in FIGS. 23 and 24, so that the original coin actuator can be re-connected easily to restore the machine to coin operation, or to enable simultaneous coin and object operation, or to enable multiple object detectors to be connected to the coin signal input of the machine. The third step is optional: to disconnect the coin actuator of the machine so that it is now only object-operated. The fourth step is also optional: connecting additional object actuators to the coin input signal of the machine. This may be done using the RJ type connectors illustrated in FIGS. 22-23, or by other ways of ensuring electrical conductivity with at least one coin input signal (there may be more than one in some machines) of the machine.

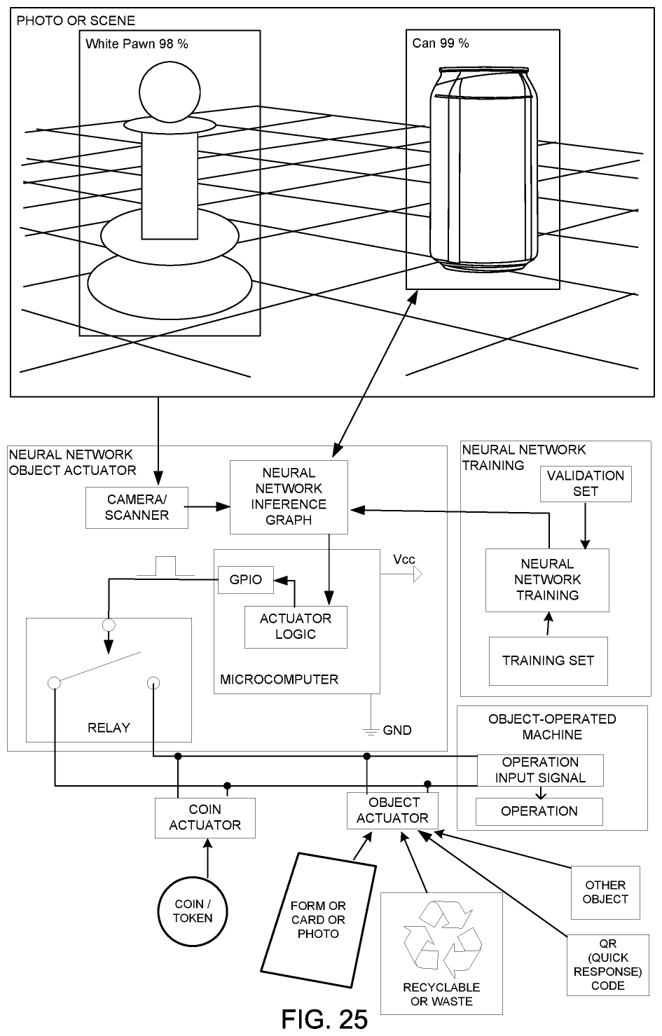

FIG. 25 illustrates an embodiment of an object detector having multiple examples of object actuators connected to an object-operated machine according to a preferred embodiment of the application. As shown in the drawing, a camera or a scanner can be used with a convolutional neural network to monitor a video stream of a scene or a photo respectively for the detection of a specific object or set of objects. As shown, the scene or photo includes two objects: a white pawn and a can. A neural network training component, such as the machine of FIG. 1 running the Ubuntu operating system, and having python and Tensorflow installed, to process a set of labelled images of objects to train a neural network inference graph. The set of labelled images is first split into a training set and a validation set. The training set is used to change the weights of the neural network inference graph, and the validation set is used to confirm that the inference graph produces results with a high enough accuracy. The resulting neural network inference graph is either used in the same machine that it was trained in, or for cost saving measures a less expensive and less powerful instance of the machine of FIG. 1, a microcomputer such as a machine running the Raspbian operating system such as a Raspberry Pi. Actuator logic uses the neural network inference graph to detect objects in the scene or photo received from a camera or scanner, respectively, in order to drive an object signal out of a general purpose input/output (GPIO) pin to actuate a relay which has been connected onto the pair of wires of the object operation signal of an object-operated machine. As illustrated, another object actuator has been connected in parallel with the neural network object actuator as well as an existing coin actuator such that the object operated machine illustrated can be activated by objects in a scene or photo, a card, a form, a photo, a recyclable object, a waste object, a QR code, or any other object that a person of ordinary skill in the art requires for a specific application. The coin actuator in this example remained connected to the coin input signal, but in alternative embodiments the coin actuator is either connected or disconnected to provide an object only operated machine.

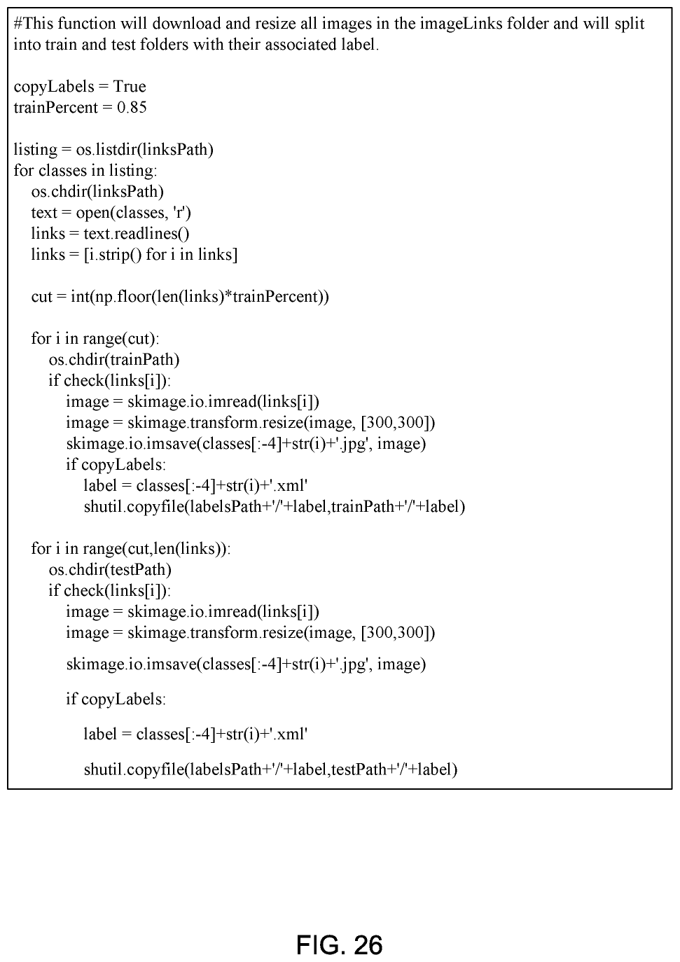

FIGS. 26, 27A, 27B, 28A and 28B list typical source code that can be utilised to train a convolutional neural network such as tensorflow to detect any kind of object in the neural network training machine of FIG. 25. FIG. 26 lists python source code to resize images and split them into the training and validation set of FIG. 25, such as taught, for example by Justin Francis, using python and the tensorflow library from Google® at https://web.archive.org/web/20171026000532/https://www.oreilly.com/ideas/object-detection-with-tensorflow, which is incorporated herein by reference. The python source code of FIG. 26 resizes images and splits them into a train and test set. A trainPercentage variable is used to split the images into a training set and a test or validation set—in the example 85% was used for training and 15% used for test or validation. In order to train the object detection model, for each image a structure known as a bounding box (xmin, xmax, ymin, ymax) for the region of interest inside an image of width, height, containing examples of the object must be created for each image of the training set. The LabelImg software available at https://web.archive.org/web/20170930174855/https://github.comhzutalin/labelImg, which is incorporated herein by reference, can be used, for example, to create these structures.

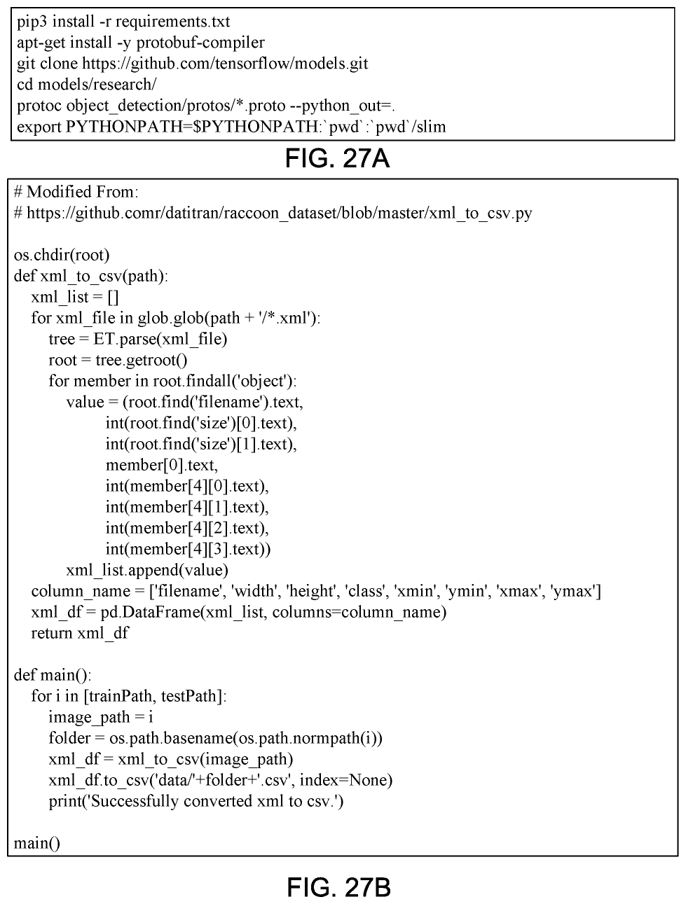

FIG. 27A lists source code that can be executed in a shell script in order to use the object API, such as bash in Ubuntu of the neural network training machine of FIG. 25. Once the object API has been installed, FIG. 27B lists instructions in python source code so that the labels can be converted to the TFRecord format required by tensorflow. A person of ordinary skill in the art would be able to convert the labels into any other format required by any other neural network architecture in view of the present disclosure for a given application. Depending on the application, one chooses a model. For example, single shot detection (SSD) network is good for detecting video feed at high speed. MobileNet model is designed to be used in mobile applications. For example, a config file that can be used is https://web.archive.org/web/*/https://github.com/tensorflow/models/blob/master/research/object_detection/samples/configs/ssd_mobilenet_v1_pets.config, which is incorporated herein by reference.

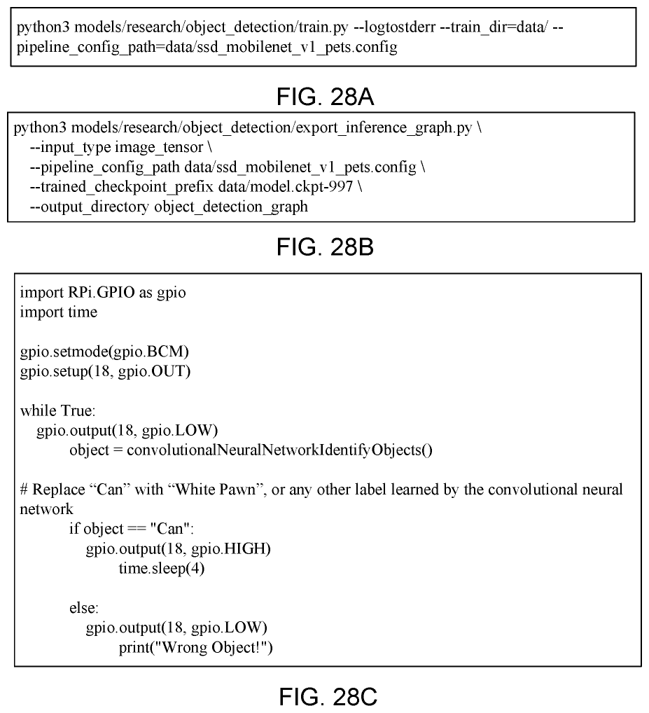

FIG. 28A lists instructions that can be executed on the neural network training machine of FIG. 25 to retrain the model with data specific to the objects that are desired to be detected.

FIG. 28B lists instructions that can be executed on the neural network training machine of FIG. 25 to provide the neural network inference graph of FIG. 25. The instructions implement a new model with Tensorflow and export the neural network inference graph of FIG. 25, using the latest ckpt # from the data directory.

FIG. 28C lists python code that can be executed on the microcomputer of FIG. 25 to provide the actuator logic block of FIG. 25 and use the neural network inference graph of FIG. 25 to provide a pulse signal of a fixed duration when an object is detected. For example, if the microcomputer of FIG. 25 can be an instance of machine of FIG. 1, such as a Raspberry Pi micro-computer, using the code of FIG. 28C to drive a relay (active high, i.e. when driven with HIGH output, the relay causes the two inputs to be connected) to connect the two-wires typically connected to a coin actuator, and therefor provide a coin input signal to a machine to operate it whenever the convolutional neural network recognizes a specific object that it has been trained for (in this example, the object required to operate the machine is a recyclable can, but could easily be the white pawn from a chess set).

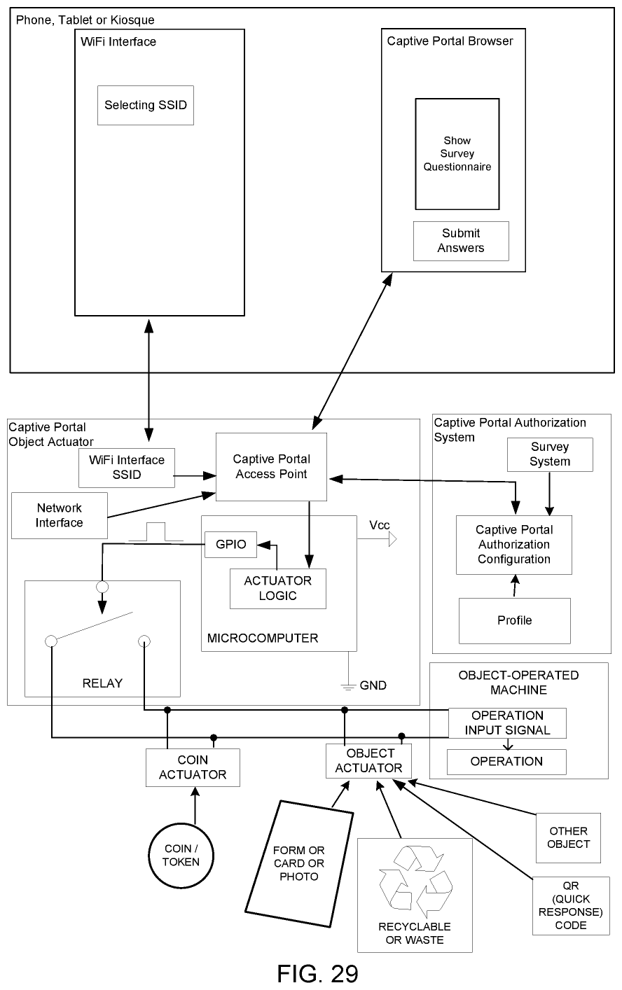

FIG. 29 illustrates an embodiment of an object detector having multiple examples of object actuators connected to an object-operated machine according to a preferred embodiment of the application. As shown in the drawing, a Phone Tablet or Kiosk can be used with a captive Portal Object Actuator. As shown, the Wifi Interface connects the two components. A captive portal authorization component, such as the machine of FIG. 1 running the Raspbian or other Linux like operating system, and having python installed, to process SSID selection and Wifi joining requests of a phone, tablet or kiosk, or more generally to any node that attempts to access the internet using either the wifi interface, the wired interface or any other network interface. A Captive Portal Access point, such as one running on Open WRT based system, operates captive portal software to request authorization from the captive portal authorization system. In the example shown, Captive Portal Authorization uses a Survey System to serve a survey that is shown to the Captive Portal Browser of the Phone, Tablet, or Kiosk. The Captive Portal Browser enables the user to submit answers, and in response to that action, depending on the Captive Portal Configuration, the captive portal either notifies the Captive Portal Object Actuator to issue an object signal to the object operated machine, or stores the signal in a profile. It is the phone, tablet or kiosk that is being detected by the captive portal access system that is the object in this case such that the object-operated machine is still operating on the basis of the presence of an object, albeit requiring some user interaction to validate the presence of a user operating the object. For efficiency, the same database used for the survey system can be used to store the user profile, such as MySQL. One survey system is LimeSurvey, but others can be used. One Captive Portal Access Point is nodogsplash, and a captive portal authorization system such as python code written using flask. In an alternative embodiments, the Captive Portal Authorization System and the Captive Portal Object Actuator are provided on a single instance of the machine of FIG. 1, a microcomputer such as a machine running the Raspbian operating system such as a Raspberry Pi. In yet an alternative embodiment, a single Captive Portal Authorization System is shared amongst several instances of the Captive Portal Object Actuator, with each running on different instances of the machine in FIG. 1, the Captive Portal Object Actuator running on a Raspberry Pi and serving the WiFi, and the Captive Portal Authorization System running in the cloud. As with the embodiment of FIG. 25, in order to drive an object signal out of a general purpose input/output (GPIO) pin to actuate a relay which has been connected onto the pair of wires of the object operation signal of an object-operated machine. As illustrated, another object actuator has been connected in parallel with the neural network object actuator as well as an existing coin actuator such that the object operated machine illustrated can be activated by objects in a scene or photo, a card, a form, a photo, a recyclable object, a waste object, a QR code, or any other object that a person of ordinary skill in the art requires for a specific application. The coin actuator in this example remained connected to the coin input signal, but in alternative embodiments the coin actuator is either connected or disconnected to provide an object only operated machine.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein, and in the appended claims

What is claimed is:

1. An apparatus for operating a coin-operated machine using an object other than a traditional coin, the machine normally operable when receiving an operation input signal from a coin actuator, the apparatus comprising:
(a) an object signal generator to generate an object signal;
(b) a connecting component for connecting the object signal to the operation input signal of the coin-operated machine; and
(c) an object detection component for triggering the object signal generator to generate the object signal connected to the operation input signal of the coin-operated machine in response to the object being detected by the apparatus;
thereby enabling the coin-operated machine to be operable using the object.

2. The apparatus of claim 1, wherein the signal generator and the object detection component are provided by an electromechanical lever actuator assembly.

3. The apparatus of claim 2, wherein the electromechanical lever actuator assembly includes a lever actuator including a wire.

4. The apparatus of claim 2, wherein electromechanical lever actuator assembly includes a lever actuator including a plate.

5. The apparatus of claim 1, wherein the object signal generator includes a relay for driving the operation input signal of the coin-operated machine.

6. The apparatus of claim 5, further including a microcomputer for generating a general purpose input output (GPIO) signal to drive the relay.

7. The apparatus of claim 6, wherein the microcomputer includes actuator logic for driving the GPIO signal.

8. The apparatus of claim 7, wherein the object detection component includes a neural network inference graph.

9. The apparatus of claim 8, further including a neural network training component for training the neural network inference graph to detect specific classes of objects.

10. The apparatus of claim 1, further including one of a camera or a scanner.

11. The apparatus of claim 1, wherein the object detection component includes a network interface and a captive portal access point for detecting the presence of a node as the object.

12. The apparatus of claim 11, wherein the object detection component includes a wifi interface operating over an SSID.

13. The apparatus of claim 11, wherein the captive portal access point communicates with a captive portal authorization system that serves a web page to the captive portal browser of the node including a survey questionnaire.

14. The apparatus of claim 13, wherein the object signal is credited to a user profile when a user of the node submits answers to the survey.

15. The apparatus of claim 14, wherein the object signal is debited from a user profile by the user used to actuate the object operated machine.

16. The apparatus of claim 13, wherein the object signal is used to actuate the object operated machine when a user of the node submits answers to the survey.

17. A method of using the object-operated apparatus of claim 1 for converting a coin-operated machine to an object-operated machine, the method comprising the steps of:
(a) identifying a coin signal input of the machine; and
(b) connecting an object signal of the object actuator to the coin input signal of the machine.

18. The method of claim 17, further comprising the step of disconnecting the coin actuator of the machine so that the machine is now only object-operated.

19. The method of claim 17, further comprising the step of connecting an additional object actuator to the coin input signal of the machine.

20. A method of for providing an apparatus for operating a coin-operated machine using an object other than a traditional coin, the machine normally operable when receiving an operation input signal from a coin actuator, the method comprising:
(a) providing an object signal generator to generate an object signal;
(b) providing a connecting component for connecting the object signal to the operation input signal of the coin-operated machine; and
(c) providing an object detection component for triggering the object signal generator to generate the object signal connected to the operation input signal of the coin-operated machine in response to the object being detected by the apparatus;
thereby enabling the coin-operated machine to be operable using the object.
